(19) United States
(12) Patent Application Publication
(10) Pub. No.: US 2024/0108072 A1
(43) Pub. Date: Apr. 4, 2024

(54) APPARATUS FOR HEATING AEROSOLISABLE MATERIAL

(71) Applicant: NICOVENTURES TRADING LIMITED, London (GB)

(72) Inventors: Luke WARREN, London Greater London (GB); Matthew HODGSON, London Greater London (GB); Andy SUTTON, London Greater London (GB); Connor MCGRATH, London Greater London (GB); Anton KORUS, Derby Derbyshire (GB)

(21) Appl. No.: 18/263,946

(22) PCT Filed: Feb. 7, 2022
(86) PCT No.: PCT/EP2022/052909

§ 371 Date: Aug. 2, 2023

(30) Foreign Application Priority Data
Feb. 10, 2021 (GB) 2101853.6

(51) Int. Cl. A24F 40/465; A24F 40/20; H05B 6/10

(52) U.S. Cl. CPC A24F 40/465; A24F 40/20; H05B 6/108

(57) ABSTRACT

An apparatus arranged to heat aerosolizable material to volatilize at least one component of the aerosolizable material is described. The apparatus has a heating zone to receive at least a portion of an article that includes aerosolizable material. The apparatus also has a magnetic field generator including a helical inductor coil to generate a varying magnetic field. The helical inductor coil defines an inductor zone within the inductor coil. The apparatus also has an elongate heating element which is heatable by penetration with the varying magnetic field and arranged to heat the heating zone. The elongate heating element extends between the heating zone and the inductor zone.

### PRIORITY CLAIM

The present application is a National Phase entry of PCT Application No. PCT/EP2022/050284, filed Jan. 7, 2022, which claims priority from U.S. Application No. 63/199,565, filed Jan. 8, 2021, each of which is hereby fully incorporated herein by reference.

### TECHNICAL FIELD

The present disclosure relates to an apparatus for heating aerosolizable material to volatize at least one component of the aerosolizable material. The present disclosure also relates to an elongate heating element for use in apparatus for heating aerosolizable material, an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an apparatus configured to heat aerosolizable material to volatilize at least one component of the aerosolizable material, the apparatus comprising: a heating zone configured to receive at least a portion of an article that includes aerosolizable material; a magnetic field generator including a helical inductor coil configured to generate a varying magnetic field, the helical inductor coil defining an inductor zone within the inductor coil; and an elongate heating element which is heatable by penetration with the varying magnetic field and arranged to heat the heating zone; wherein the elongate heating element extends between the heating zone and the inductor zone.

The coil may be supported on a mount.

The coil may comprise a wire. The coil may comprise a conductive film.

The elongate heating element may define a longitudinal axis. The helical inductor coil may be spaced from the heating zone in the axial direction.

The elongate heating element may protrude in the heating zone.

The elongate heating element may upstand from a base. The elongate heating element may comprise a sharp edge or point at a free end. The elongate heating element may be a pin or blade. The elongate heating element may be configured to extend into the article received by the heating region.

The apparatus may comprise a receptacle defining the heating zone. The helical inductor coil may not overlap the receptacle.

The receptacle may comprise an end wall defining a closed end of the heating zone. The end wall may be between the heating zone and the helical inductor coil.

The receptacle may comprise a peripheral wall defining the heating zone. A spacing between the peripheral wall and the heating element may be greater than a spacing between the helical inductor coil and the elongate heating element.

A maximum width of the helical inductor coil may be less than a maximum width of the heating zone.

An inner diameter of the helical inductor coil may be less than an outer diameter of the heating zone.

A maximum outer width of the helical inductor coil may be less than a maximum outer width of the heating zone.

A maximum outer diameter of the helical inductor coil may be less than a maximum outer diameter of the receptacle.

The heating element may comprise a first portion exposed to the heating zone, and a second portion external to the heating zone. The helical inductor coil may encircle the second portion.

The first and second portions may be integrally formed. As used herein, the term ‘integrally formed’ is intended to mean that the features are not separable.

The second portion may be fluidly isolated from the heating zone.

The first portion may be a heating portion. The second portion may be a base portion. The heating portion and base portion may be co-axial.

The heating portion and base portion may be thermally conductively connected between. As used herein, the term ‘conductively connected between’ does not necessarily mean that two features are directly connected between, and such an arrangement may include one or further features therebetween. The heating portion and base portion may be thermally directly conductively connected therebetween. The heating portion and base portion may be thermally indirectly conductively connected therebetween, for example by an intermediate member. As used herein, the term ‘conductively connected between’ is intended to mean the primary means of heat transfer between the heating portion and base portion.

The thermal conductivity of the heating portion may be greater than the thermal conductivity of at least part of the base portion.

At least part of the heating portion may comprise a first material and at least part of the base portion may comprise a second material.

The first material may have a lower susceptibility to being heated by penetration with the varying magnetic field than the susceptibility of the second material.

The thermal conductivity value of the first material may be greater than the thermal conductivity value of the second material.

A radial width of at least part of the second portion may be greater than a radial width of the first portion.

The second portion may comprise a collar.

The second portion may comprise a core. The collar may at least partially encircle the core.

The core may be formed as a one part component with the first portion. That is, the features are formed together such that no joints are defined therebetween.

The first portion and core may be an elongate member. The elongate member may be a rod.

The elongate member may be a heat pipe.

The collar may include heater material that is heatable by penetration with the varying magnetic field.

The collar may be tubular. The collar may be a foil layer. The collar may be a mesh. The susceptor may be a wire formed as a winding. The wire may have a serpentine arrangement. The collar may be a solid member.

The thermal conductivity of at least part of the first portion may be greater than the thermal conductivity of at least part of the second portion.

At least part of the first portion may have a lower susceptibility to being heated by penetration with the varying magnetic field than at least part of the second portion.

At least part of the first portion of the heating element may comprise a non-ferrous material and at least part of the second portion may comprise a ferrous material.

The collar may comprise a ferrous material.

The heating element may comprise a heat pipe.

The heat pipe may extend between the heating zone and the inductor zone.

The inductor zone may have an axial length at least 25% of the heating zone.

According to an aspect, there is provided an apparatus configured to heat aerosolizable material to volatilize at least one component of the aerosolizable material, the apparatus comprising: a body comprising a cavity for receiving an article comprising aerosol generating material; a magnetic field generator assembly including a helical inductor coil; a heater member comprising: a first portion exposed to the cavity arranged to heat the cavity; and a second portion received by the helical inductor coil to be heated by the magnetic field generator assembly; wherein the first portion is offset from the helical inductor coil and is arranged to be heated by conduction from the second portion.

The apparatus of this aspect can include one or more, or all, of the features described above, as appropriate.

According to an aspect, there is provided an elongate heating element for use in apparatus for heating aerosolizable material to volatilize at least one component of the aerosolizable material, wherein the elongate heating element defines a longitudinal axis and comprises an elongate heating portion and an elongate susceptor portion, wherein the elongate heating portion protrudes in an axial direction from the elongate susceptor portion.

The width of the elongate heating portion may be greater than the length of the elongate heating portion along the longitudinal axis. The width of the elongate susceptor portion may be greater than the length of the elongate heating portion along the longitudinal axis.

The elongate heating portion may comprise a first material, and the elongate susceptor portion may comprise a second material.

The first material may have a higher conductivity than the second material.

According to an aspect, there is provided an aerosol provision device comprising at least one of the apparatus as set out above.

According to an aspect, there is provided an aerosol provision device comprising at least one of the elongate heating elements as set out above.

According to an aspect, there is provided an aerosol provision device comprising at least one of the apparatus as set out above and at least one of the elongate heating elements as set out above.

The aerosol provision device may be a non-combustible aerosol provision device.

The device may be a tobacco heating device, also known as a heat-not-burn device.

According to an aspect, there is provided an aerosol provision system comprising an aerosol provision device described above, and an article comprising aerosol generating material.

The article may be a consumable.

The aerosol generating material may be non-liquid aerosol generating material.

The article may be dimensioned to be at least partially received within the heating region.

### BRIEF DESCRIPTION OF THE DRAWINGS

Embodiments will now be described, by way of example only, and with reference to the accompanying drawings in which:

FIG. 1 shows a front perspective view of an aerosol provision device.

FIG. 2 shows schematically the aerosol provision device of FIG. 1.

FIG. 3 shows a side view of part of a heating assembly of FIG. 2 with an article comprising aerosol generating material.

FIG. 4 shows a cross-sectional side view of part of the heating assembly of FIG. 3 with the article comprising aerosol generating material.

FIG. 5 shows schematically a perspective view of the heating assembly of FIG. 3.

FIG. 6 shows schematically a side view of another heating assembly of the aerosol provision device of FIG. 2.

FIG. 7 shows schematically a side view of a heating element of the aerosol provision device of FIG. 2.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

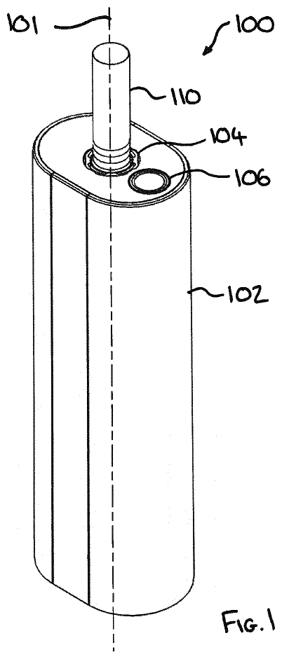

FIG. 1 shows an example of an aerosol provision device 100 for generating aerosol from an aerosol generating medium/material. The device 100 can be used to heat a replaceable article 110 comprising the aerosol generating medium, to generate an aerosol or other inhalable medium which can be inhaled by a user of the device 100.

The device 100 comprises a housing 102 which surrounds and houses various components of the device 100. The device 100 has an opening 104 in one end, through which the article 110 can be inserted for heating by the device 100. The article 110 may be fully or partially inserted into the device 100 for heating by the device 100.

The device 100 may comprise a user-operable control element 106, such as a button or switch, which operates the device 100 when operated, e.g. pressed. For example, a user may activate the device 100 by pressing the switch 106.

The device 100 defines a longitudinal axis 101, along which an article 110 may extend when inserted into the device 100.

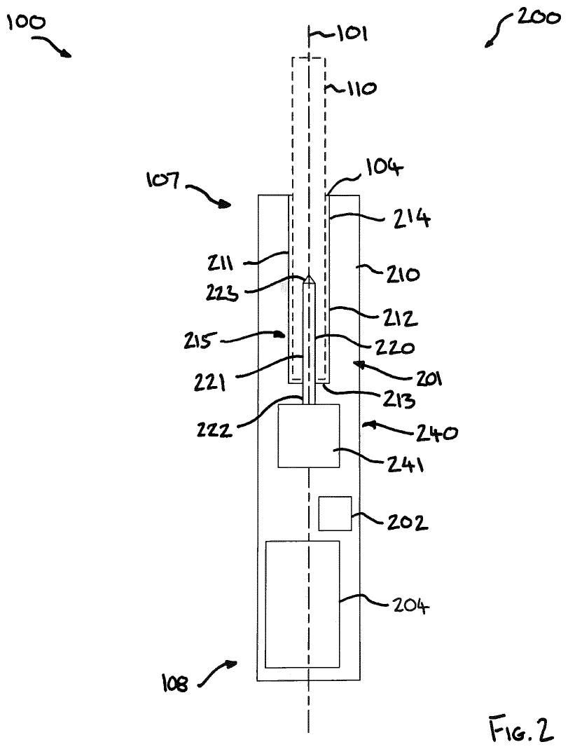

FIG. 2 is a schematic illustration of the aerosol provision device 100 of FIG. 1, showing various components of the device 100. It will be appreciated that the device 100 may include other components not shown in FIG. 2.

As shown in FIG. 2, the device 100 includes an apparatus for heating aerosolizable material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol generating medium of an article 110 inserted into the device 100, such that an aerosol is generated from the aerosol generating medium. The power source 204 supplies electrical power to the heating assembly 201, and the heating assembly 201 converts the supplied electrical energy into heat energy for heating the aerosol generating medium.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The battery 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 100 closest to the opening 104 may be known as the proximal end (or mouth end) 107 of the device 100 because, in use, it is closest to the mouth of the user. In use, a user inserts an article 110 into the opening 104, operates the user control 106 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end 108 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214.

The heating chamber 211 is defined by the inner walls of the receptacle 212. The receptacle 212 acts as a support member. The receptacle comprises a generally tubular member extending along and around and substantially coaxial with the longitudinal axis 101 of the device 100. However, other shapes would be possible. The receptacle 212, and so heating chamber 211, is open at its proximal end such that an article 110 inserted into the opening 104 of the device 100 can be received by the heating chamber 211 therethrough. The receptacle 212 is closed at its distal end by the end wall 213. The receptacle 212 may comprise one or more conduits that form an air passage. In use, the distal end of the article 110 may be positioned in proximity or engagement with the end of the heating chamber 211. Air may pass through the one or more conduits, into the heating chamber 211, and flow through the article 110 towards the proximal end of the device 100.

The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 100. The receptacle 212 may be formed from a rigid material to aid support of other components.

Other arrangements for the receptacle 212 would be possible. For example, in an embodiment the end wall 213 is defined by part of the heating assembly 201, for example a circumferentially extending flange.

As illustrated in FIG. 2, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating element 220 is heatable to heat the heating zone 215. The heating element 220 is an induction heating element. That is, the heating element 220 comprises a susceptor that is heatable by penetration with a varying magnetic field. The heating element 220 comprises a first portion, herein referred to as a heating portion 221, and a second portion, herein referred to as a base portion 222. At least part of the base portion 222 acts as the susceptor.

The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240. The magnetic field generator 240 is configured to generate one or more varying magnetic fields that penetrate the susceptor so as to cause heating in the susceptor. The magnetic field generator 240 includes a helical inductor coil 241, acting as an inductor element, and shown schematically in FIG. 2.

In some examples, in use, the inductor coil is configured to heat the susceptor to a temperature of between about 200° C. and about 350° C., such as between about 240° C. and about 300° C., or between about 250° C. and about 280° C.

FIGS. 3, 4 and 5 illustrate an embodiment of the heating assembly 201 in more detail. It will be appreciated that the heating assembly 201 may include other components not shown in FIGS. 3 to 5.

As shown in FIGS. 3 to 5, the heating assembly 201 comprises the heating element 220 and the magnetic field generator 240. The helical inductor coil 241 of the magnetic field generator 240 is shown in the FIGS. 3 to 5.

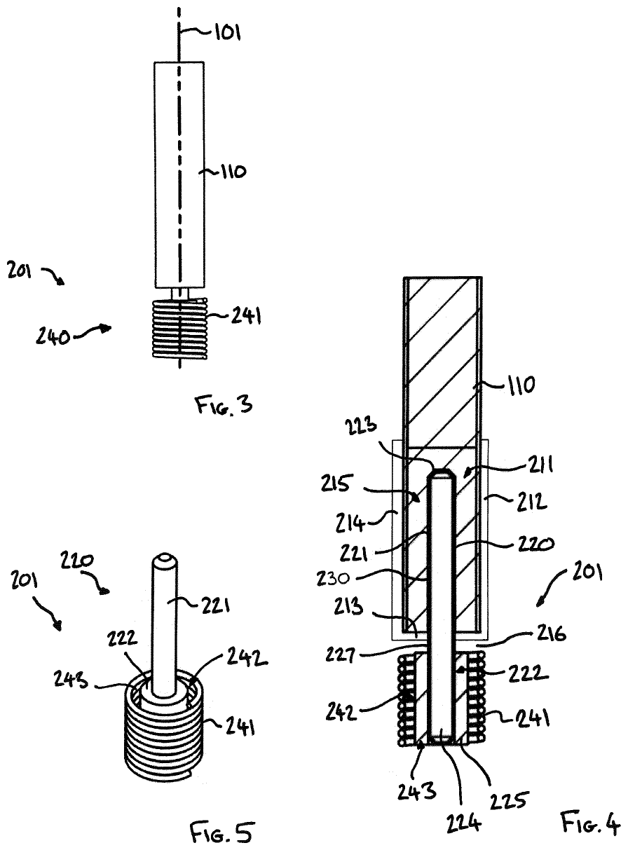

The heating element 220 extends in the heating zone 215. The heating portion 221, acting as a protruding element, protrudes in the heating zone 215. The heating element 220 is spaced from the peripheral wall 214. The heating assembly 201 is configured such that when an article 110 is received by the heating chamber 211, the heating portion 221 of the heating element 220 extends into a distal end of the article 110. The heating portion 221 of the heating element 220 is positioned, in use, within the article 110 as shown in FIGS. 3 and 4. The heating element 220 is configured to heat aerosol generating material of an article 110 from within, and for this reason is referred to as an inner heating element. To facilitate this, the inner heating element 220 is configured to pierce an article 110 that is inserted into the device 100.

In the present embodiment, the heating portion 221 of the heating element 220 comprises a sharp edge or point at its proximal end 223. The proximal end is the free end of the heating element 220. The heating portion 221 is a pin. Other shapes are envisaged, for example the heating portion 221 in embodiments is a blade. The heating portion 221 may extend into the heating chamber 211 from the distal end of the heating chamber 211 along the longitudinal axis 101 of the device (in the axial direction). In embodiments the heating portion 221 extends into the heating chamber 211 spaced from the axis 101. The heating portion 211 may be off-axis or non-parallel to the axis 101. Although one heating portion 221 of the heating element 220 is shown, it will be understood that in embodiments, the heating element 220 comprises a plurality of heating portions 221. Such heating portions in embodiments are spaced from but parallel to each other.

The heating element 220 extends from the heating zone 215. The heating element 220 extends external to the heating zone 220. The heating element 220 is received through the receptacle 212. The heating element 220 extends through the end wall 213. The helical inductor coil 241 is disposed external to the receptacle 212. The helical inductor coil 241 is spaced from the end wall 213. A gap 216 is provided between the receptacle 212 and the helical inductor coil 241. In embodiments, an insulation member (not shown) is provided in the gap 216. In embodiments, the helical inductor coil 241 is mounted to the end wall 213. In embodiments the inductor coil 241 is spaced from the end wall 213. Base portion 222 is shown external to the heating chamber 211. The heating element 220 may comprise an intermediate portion 225 between the heating portion 221 and the base portion 222. The intermediate portion 225 may extend between the helical inductor coil 241 and the heating chamber 211. The intermediate portion 225 extends through the end wall 213. In embodiments, the intermediate portion 225 is omitted or forms part of one of the heating portion 221 and the base portion 222.

The helical inductor coil 241 extends around at least a portion of the base portion 222, acting as a susceptor. The helical inductor coil 241 is configured to generate a varying magnetic field that penetrates the base portion 222.

The inductor coil 241 is a helical coil comprising electrically-conductive material, such as copper. The coil is formed from wire, such as Litz wire, which is wound helically around a support member (not shown). The support member (not shown may be omitted. The support member is tubular. The coil 241 defines a generally tubular shape. The helical coil 241 defines an inductor zone 242, The helical coil 241 defines a bore 243.

The inductor coil 241 has a generally circular profile. In other embodiments, the inductor coil 241 may have a different shape, such as generally square, rectangular or elliptical. The coil width may increase or decrease along its length.

The base portion 222 of the heating element 220 extends into the inductor coil 241. That is, the helical inductor coil 241 defines the inductor zone 242 in an enclosed space. The inductor zone 242 is a space defined by the inductor coil 241 in which a feature is receivable to be heatable by penetration with a varying magnetic field generated by the inductor coil 241.

Other types of inductor coil are known, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximized. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid.

The configuration of the helical inductor coil may vary along its axial length. For example, the inductor coil, or each inductor coil, may have substantially the same or different values of inductance, axial lengths, radii, pitches, numbers of turns, etc.

The helical inductor coil 241 may extend around, and be supported by, the support member (not shown). The helical inductor coil 241 is arranged coaxially with the heating chamber 211 and longitudinal axis 101.

Where the base portion 222 extends through the inductor zone 242 the base portion 222 is susceptible to varying magnetic flux along its length.

The heating element 220 comprises the base portion 222 with the heating portion 221 protruding from the base portion 222. The heating portion 221 is heatable by the base portion 222 by thermal conduction. The heating portion 221 and base portion 222 are thermally conductively connected. The base portion 222 has a greater radial extent than the heating portion 221. The base portion 222 is generally cylindrical, however other shapes are anticipated.

The elongate heating portion 221 extends at its distal end from the base portion 222. The elongate heating portion 221 and the base portion 222 are coaxial. The base portion 222 has an axial height. The axial height of the base portion 222 substantially corresponds to the axial length of the of the inductor zone 242. Such an arrangement aids to maximize the magnetic flux intersecting with the base portion 222.

The base portion 222 comprises a core 224 and a collar 225. The core 224 is an extension of the heating portion 221. The core 224 and the heating portion 221 form part of a heating member 230. The core 224 is integrally formed with the heating portion 221 as a one-piece component.

The core 224 of the base portion 222 and the heating portion 221 form part of an elongate rod. The intermediate section 227 in embodiments is defined therebetween. In such an arrangement the heating portion 221 is defined by the part of the heating member 230 extending in the heating zone 215. The core 224 is defined by the part of the heating member 230 extending in the collar 225. The base portion 222 is defined by the part of the member extending in the inductor zone 242.

The core 224 has a corresponding radial width to the heating portion 221. The rod has a generally constant cross sectional area and profile along its length. In embodiments, one or both of the cross sectional area and profile may vary along the length. By forming the core 224 and the heating portion 221 together it is possible to aid heat conduction along the heating element 220. The core 224 is conductively connected to the collar 225. Accordingly, heat transfer from the collar 225 to the core 224 occurs by conduction when the collar 225 is heated. The collar 225 forms an interference fit with the core 224. The collar 225 may be connected to the core 224 by different means.

The collar 225 encircles the core 224. In embodiments the collar 225 partially encircles the core 224. In the present embodiment the collar 225 is tubular. The collar 225 defines an outer layer of the core 224. The heating portion 221 protrudes above the collar 225.

The heating portion 221 has a thermal conductivity greater than the thermal conductivity of the collar 225. The collar 225 is formed from a different material. The base portion 222 and the heating element 220 have different thermally conductive properties. The collar 225 acts as the susceptor, and is formed from a material susceptible to being heated by penetration with the varying magnetic field. The collar 225 comprises electrically conducting material suitable for heating by electromagnetic induction. For example, the susceptor may be formed from a carbon steel. It will be understood that other suitable materials may be used, for example a ferromagnetic material such as iron, nickel or cobalt.

The collar 225 as shown in FIGS. 3 to 5 has a solid configuration. The collar 225 is shown as tubular. In embodiments the configuration of the collar differs. The collar in an embodiment is a foil layer. The collar may be an outer layer on the core 224. The collar in embodiments is a mesh. The collar, acting as the susceptor, in embodiments is a wire. The collar may comprise a plurality of wires. A wire arrangement 425 acting as a susceptor is shown in FIG. 7. The wire arrangement 425 forms a collar. The wire is formed as a winding around a core 424 of a heating element 420. The collar has a serpentine arrangement. The wire arrangement 425 comprises a plurality of longitudinally extending portions 426 with end turns 427. It will be understood that the configuration of the wire arrangement 425 may differ. For example, the wire arrangement 425 forming the susceptor may have a helical configuration.

In an embodiment, the member forming the heating portion 221 comprises a heat pipe. The heat pipe is an elongate member. The heat pipe acts to enhance heat transfer along the length of the heating element 220.

A heat pipe 230 is a closed evaporator-condenser system. The heat pipe includes a sealed, hollow tube. A wick is disposed in the tube. The inside walls of the heat pipe are lined with a capillary structure or wick. A thermodynamic working fluid, having substantially vapor pressure at the desired operating temperature, saturates the pores of the wick in a state of equilibrium between liquid and vapor. When heat is applied to the heat pipe, the liquid in the wick is heated causing the fluid to evaporate. The evaporated fluid fills a hollow center of the heat pipe and diffuses throughout its length.

With respect to the forgoing, tubular is intended to mean a member with a central bore. Such a heat pipe may be an elongate member, a plate, or have another cross-sectional appearance.

The heat pipe is formed from copper. The working fluid is water. Other configurations are anticipated. For example, the heat pipe may be formed from one of copper, aluminum, and austenitic nickel chromium. The heat pipe may be formed from stainless steel. The heat pipe may comprise a working fluid comprising water. The heat pipe may comprise a working fluid comprising one or more of acetone, carbon dioxide, and ammonia.

The heat pipe in embodiments includes a working fluid having an operating temperature, in use, of about 200° C. and about 350° C., such as between about 240° C. and about 300° C., or between about 250° C. and about 280° C.

With such configurations, the heating element has an effective thermal conductivity of greater than 3000 W/m-k, such as greater than 4000 W/m-k, and such as greater than 5000 W/m-k.

In embodiments, the heating element has an effective thermal conductivity of between 3000 and 100000 W/m-k, and such as between 4000 and 10000 W/m-k.

The heat pipe 230 has a diameter of about 3 mm. The diameter of the heat pipe in embodiments is between about 1 mm and 10 mm, such as between about 2 mm and 5 mm, and such as between about 3 mm and 4 mm.

The heat pipe 230 has a length of about 50 mm. The length of the heat pipe in embodiments is between about 10 mm and 100 mm, such as between about 30 mm and 70 mm, and such as between about 40 mm and 60 mm.

The core 224 has a thermal conductivity greater than the thermal conductivity of the collar 225. The core 224 is formed from a material having a high thermal conductivity, for example copper and aluminum.

The material of the heating portion 221 has a lower susceptibility to being heated by penetration with the varying magnetic field than the susceptibility of the collar 225. The material forming the collar 225 has a higher susceptibility to being heated by penetration with the varying magnetic field than the susceptibility of the heating portion 221. The material of the heating portion 221 is a non-ferrous material. The material of the collar 225 is one of a ferromagnetic and paramagnetic material.

The high thermal conductivity of the heating portion 221 aids heat transfer. Accordingly, when the collar 225 is heated, the thermal transfer of heat along the heating portion 221 is maximized. This aids a more uniform heating of the elongate heating member along the axial length.

Although as described above the base portion 222 comprises a core and a collar, in embodiments, the base portion defines the susceptor without a core portion extending in the susceptor. In another embodiment the collar is an extension of the heating portion having a constant cross-sectional profile along the length of the heating element 220 between the heating portion 221 and the core 224 as described below.

The elongate inductor zone 242 is axially offset from the heating zone 215. By providing the helical inductor coil 241 offset from the receptacle 212 it is possible to aid a minimization of the radial extent of the helical inductor coil 241. The helical inductor coil 241 is offset from the heating portion, and so does not extend around the heating chamber. Accordingly the dimensions of the inductor coil are not constrained by the dimensions of the heating chamber.

The spacing between the peripheral wall and the heating element is greater than a spacing between the helical inductor coil and the heating element. Accordingly it is possible to provide an efficient spacing of helical coil to susceptor and a desired size of article received by the device.

In embodiments, the maximum width of the helical inductor coil is less than a maximum width of the heating zone. Accordingly the insulation arrangement around the inductor coil may be enhanced.

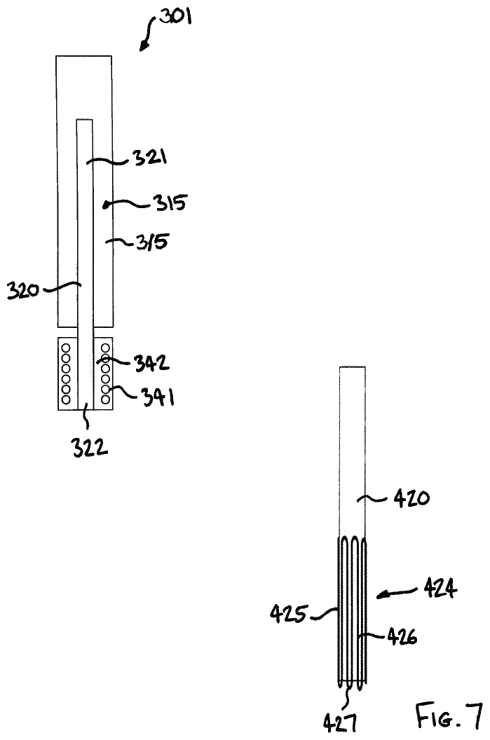

As shown in FIG. 6, another configuration of the heating assembly 301 is shown. It will be appreciated that the heating assembly 301 may include other components not shown in FIG. 6. The configuration of the device 100 is generally as described above and so a detailed description will be omitted. As described below the arrangement of the heating element differs.

In the configuration shown in FIG. 6, the base portion does not comprise a collar forming the susceptor as described above. In this arrangement, an elongate member having a constant cross-sectional width forms the susceptor. That is, the heating element 320 is formed from a material susceptible to being heated by penetration with the varying magnetic field along its axial length.

The base portion 322 formed from a susceptor material is integrally formed with the heating portion 321 as a one-piece component. The base portion 322 in the present embodiment has a uniform cross-sectional profile with the heating portion 321. That is, the base portion 322 has a corresponding radial width to the heating portion 321. The base portion 322 is an extension of the heating portion 321. By forming the base portion 322 and the heating portion 321 together it is possible to aid heat conduction along the heating element.

The inductor zone 342 is offset from the heating zone 315, with the heating element 320 extending between the two zones.

The heating element 320 acts as the susceptor, and is formed from a material susceptible to being heated by penetration with the varying magnetic field. Part of the heating element formed from susceptor material is spaced from the inductor zone. The susceptor may be formed from a carbon steel. It will be understood that other suitable materials may be used, for example a ferromagnetic material such as iron, nickel or cobalt.

Apparatus for heating aerosolizable material using an inductively heated susceptor element are known. However, such apparatus generally use an arrangement in which a susceptor element is positioned within a heating zone configured to receive an article, and an induction coil is arranged around the heating zone (i.e., and around the susceptor element in the heating zone). As such, when the susceptor element is inductively heated by the induction coil, the region of the susceptor element which is heated by induction corresponds to the region which releases heat into the article.

With such an arrangement, the coil is sized to receive the heating zone and susceptor. The susceptor in the heating zone is configured to both act as a susceptor and to transfer heat to the article.

With the arrangements described herein, by providing the elongate heating element having a first portion in a heating zone for receiving the article, and a second portion external to the heating zone and being encircled by an induction coil, the induction process can take place in a separate region to the heating of the article. The first portion in the heating zone is able to be optimized for heat transfer to a consumable. The second portion is able to be optimized for induction.

By spacing the coil from the heating zone, the radial size of the coil may be smaller than that of the heating zone, allowing the radial dimension of the coil to be optimized for induction, as well as providing a minimum possible width of the apparatus.

By using an elongate susceptor element, which extends substantially linearly into heating and induction zones it is possible for the inductive and article heating properties to be configured in a straightforward manner by adjusting the relative length of the first and second portions in the respective heating and inductor zones. For example, the length of the second portion extending within the inductor zone can be made as long as necessary, e.g. for a particular maximum temperature, simply by extending the length of the element and the number of turns of the coil.

By providing an elongate heating element having first and second portions, each portion having a length along the longitudinal axis which is greater than the width of said portion, it is possible to have a low weight while providing said aforementioned benefits. One example of such an elongate heating element may be a heat pipe, which as discussed above has advantageous heat transfer properties.

Considering the parameters of these lengths, it may be desirable that at least a particular percentage of the elongate heating element extends into the inductor zone, so as to provide for sufficient inductive heating. For example, wherein the elongate heating element axially overlaps the heating zone such that less than 90% of the axial length of the elongate heating element axially overlaps the heating zone.

The maximum percentage length of the heating element in the heating chamber in embodiments is up to about 90%, such as up to about 80%, such as up to about 75%.

In order to transfer the inductively generated heat, it may be desirable to provide at least a particular percentage of the elongate heating element arranged beyond the inductor zone in the inductor coil. For example wherein the induction coil extends longitudinally along the longitudinal axis of the elongate heating element, and wherein the longitudinal overlap of the elongate heating element and the induction coil is less than 60% of the axial length of the elongate heating element.

The maximum percentage length of the heating element extending in the inductor coil in embodiments is up to about 60%, such as up to about 50%, such as up to about 40%.

The balance between inductive heating of the elongate heating element and the provision of heat to an article in the heating zone is an important consideration, and it can be advantageous to provide that at least a particular percentage of the elongate heating element extends within the inductor zone. For example wherein the inductor zone in the coil has an axial length at least 25% of the axial length of the heating zone.

The minimum length of the inductor coil relative to the length of the heating chamber is at least about 15%, such as at least about 20%, such as at least about 25%.

At least 25%, possibly at least 50%, possibly at least 60%, possibly at least 70% of the heating element is external to the inductor zone.

In each arrangement the inductor coil is configured to generate a varying magnetic field that penetrates the base portion, acting as a susceptor, to cause heating of the base portion, and therefore indirect conductive heating of the heating portion.

In the above described embodiments the helical inductor coil is spaced from the heating zone. Accordingly a barrier is formed to limit the varying magnetic field exposure to the heating zone, and components around the heating zone. Such an arrangement may limit heating caused to any susceptor material introduced into the heating chamber.

In the above described embodiments the heating portion is an inner heater. That is, the heating portion protrudes into the heating chamber and is arranged to be received by the article. In another embodiment the heating portion is an outer heater. In such a configuration, the heating member may be a generally tubular member extending along and substantially coaxial with the longitudinal axis 101. The heating member may extend at least partially around an axial portion of the heating chamber. The heating member may extend continuously around the entire circumference of the heating chamber, or only partially extend around the chamber. For example, one or more discontinuities, e.g. holes, gaps or slots, may be provided in the heating member. The heating member may be configured and dimensioned to extend around an article received by the heating chamber. The heating member may thus be positioned, in use, around an article. The heating member may thus be configured to heat aerosol generating material of the article 110 from outside, and for this reason be referred to as an outer heating element. The heating member may have a circular cross section, e.g. corresponding a circular cross section of the article 110. Other cross sectional shapes would be possible.

The heating member may extend along the heating region for any suitable distance. The heating member in such an embodiment may form the receptacle. The base portion is disposed at an end of the tubular member. The outer heating member may form the tubular member at one end. The base portion in such embodiments may extend one or both of axially or radially inwardly. The base portion may define the end wall. The base collar in some embodiments is a collar around the tubular member.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus configured to heat aerosolizable material to volatilize at least one component of the aerosolizable material, the apparatus comprising:
a heating zone configured to receive at least a portion of an article that includes aerosolizable material;
a magnetic field generator including a helical inductor coil configured to generate a varying magnetic field, the helical inductor coil defining an inductor zone within the inductor coil; and
an elongate heating element which is heatable by penetration with the varying magnetic field and arranged to heat the heating zone, wherein the elongate heating element extends between the heating zone and the inductor zone.

2. The apparatus of claim 1, wherein the elongate heating element defines a longitudinal axis, and the helical inductor coil is spaced from the heating zone in an axial direction.

3. The apparatus of claim 2, wherein the elongate heating element protrudes in the heating zone.

4. The apparatus of claim 3, further comprising a receptacle defining the heating zone, wherein the helical inductor coil does not overlap the receptacle.

5. The apparatus of claim 4, wherein the receptacle comprises an end wall defining a closed end of the heating zone, and wherein the end wall is between the heating zone and the helical inductor coil.

6. The apparatus of claim 4, wherein the receptacle comprises a peripheral wall defining the heating zone, and wherein a spacing between the peripheral wall and the heating element is greater than a spacing between the helical inductor coil and the elongate heating element.

7. The apparatus of claim 1, wherein a maximum width of the helical inductor coil is less than a maximum width of the heating zone.

8. The apparatus of claim 1, wherein the heating element comprises a first portion exposed to the heating zone, and a second portion external to the heating zone, wherein the helical inductor coil encircles the second portion.

9. The apparatus of claim 8, wherein a radial width of at least part of the second portion is greater than a radial width of the first portion.

10. The apparatus of claim 8, wherein the second portion comprises a collar.

11. The apparatus of claim 10, wherein the second portion comprises a core and wherein the collar at least partially encircles the core.

12. The apparatus of claim 11, wherein the core is formed as a one part component with the first portion.

13. The apparatus of claim 11, wherein the collar includes heater material that is heatable by penetration with the varying magnetic field.

14. (canceled)

15. The apparatus of claim 8, wherein a thermal conductivity of at least part of the first portion is greater than a thermal conductivity of at least part of the second portion.

16. The apparatus of claim 8, wherein at least part of the first portion has a lower susceptibility to being heated by penetration with the varying magnetic field than at least part of the second portion.

17. (canceled)

18. The apparatus of claim 1, wherein the heating element comprises a heat pipe.

19. (canceled)

20. The apparatus of claim 1, wherein the inductor zone has an axial length at least 25% of the heating zone.

21. An apparatus configured to heat aerosolizable material to volatilize at least one component of the aerosolizable material, the apparatus comprising:
a body comprising a cavity for receiving an article comprising aerosol generating material;
a magnetic field generator assembly including a helical inductor coil;
a heater member comprising:
a first portion exposed to the cavity arranged to heat the cavity and
a second portion received by the helical inductor coil to be heated by the magnetic field generator assembly,
wherein the first portion is offset from the helical inductor coil and is arranged to be heated by conduction from the second portion.

22-25. (canceled)

26. An elongate heating element for use in an apparatus for heating aerosolizable material to volatilize at least one component of the aerosolizable material, wherein the elongate heating element defines a longitudinal axis and comprises:
an elongate heating portion and
an elongate susceptor portion,
wherein the elongate heating portion protrudes in an axial direction from the elongate susceptor portion.

27. (canceled)

28. An aerosol provision system comprising the apparatus of claim 1, and an article comprising aerosol generating material.

29. (canceled)
